(19) United States
(12) Patent Application Publication
(10) Pub. No.: US 2021/0400473 A1
(43) Pub. Date: Dec. 23, 2021

(54) PROCEDURE TO UPDATE THE PARAMETERS RELATED TO UNIFIED ACCESS CONTROL

(71) Applicant: NEC Corporation, Minato-ku, Tokyo (JP)

(72) Inventors: Kundan TIWARI, Chennai (IN); Toshiyuki TAMURA, Tokyo (JP)

(73) Assignee: NEC Corporation, Minato-ku, Tokyo (JP)

(21) Appl. No.: 17/287,864

(22) PCT Filed: Oct. 28, 2019
(86) PCT No.: PCT/JP2019/042180

§ 371 Date: Apr. 22, 2021

(30) Foreign Application Priority Data
Nov. 2, 2018 (IN) 201811041578

(51) Int. Cl. H04W 12/033; H04W 12/72; H04W 12/73; H04W 48/18; H04W 76/10; H04W 76/25; H04W 12/0431; H04W 12/75

(52) U.S. Cl. CPC H04W 12/033; H04W 12/72; H04W 12/73; H04W 12/75; H04W 76/10; H04W 76/25; H04W 12/0431; H04W 48/18

(57) ABSTRACT

This disclosure defines a procedure to security protection to sensitive information in AS layer during AS connection establishment procedure. More specifically the disclosure provides a procedure for privacy protection of user subscription and location related information at AS layer during AS connection establishment procedure.

### TECHNICAL FIELD

The present disclosure relates to a mobile communication system, a user equipment, a RAN node and a communication method.

### BACKGROUND ART

The 5G System (5GS) introduces a Network Slicing function. The (Single-) Network Slice Selection Assistance Information ((S-)NSSAI) is used as an identifier for identifying the Network Slice, and the (S-)NSSAI is used among a User Equipment (UE), a 5G Access Network (5G-AN) and a 5G Core Network (5GC) in order to compliant with a service-level agreement (SLA) that the network operator engages with. The handling of the (S-)NSSAI are specified in the 3GPP TS 23.501 (NPL2), TS 23.502 (NPL3) and TS 38.331 (NPL6).

### CITATION LIST

### Non Patent Literature

NPL 1: 3GPP TR 21.905: “Vocabulary for 3GPP Specifications”. V15.0.0 (2018-03)
NPL 2: 3GPP TS 23.501: “System Architecture for the 5G System; Stage 2”. V15.2.0 (2018-06)
NPL 3: 3GPP TS 23.502: “Procedures for the 5G System; Stage 2” V15.2.0 (2018-06)
NPL 4: 3GPP TS 24.501: “Non-Access-Stratum (NAS) protocol Stage 3” V15.0.0 (2018-06)
NPL 5: 3GPP TS 38.413: “NG Application Protocol (NGAP)” V15.0.0 (2018-06)
NPL 6: 3GPP TS 38.331″: “Radio Resource Control (RRC) protocol specification” V15.3.0 (September 2018)

### SUMMARY OF INVENTION

### Technical Problem

Despite 3GPP TS 38.331 (NPL6) describes that the RRC message can carry a list of (S-)NSSAI from a UE to NG-RAN, the 3GPP SA3 group expresses their security concern that sending an (S-)NSSAI in RRC layer with clear text cannot be acceptable because user privacy cannot be guaranteed.

If NSSAI information cannot be sent from the UE to 5G-AN in RRC layer due to security reason, network slice based congestion control or initial AMF selection for requested the NSSAI or RAN based allocation of resources at 5G-AN will not work.

As a consequence, a large volume of traffic for congested network slice would reach to the AMF and the AMF might become out of control as the AMF may not able to be tenable against such big traffic.

In order to avoid such failure scenario, the 5G-AN should bar such traffic up-front of the AMF if the network slice is congested. Requested NSSAI is used for initial AMF selection. If the correct AMF is not selected during the AS connection establishment, then re-allocation of AMF takes place in many registration procedures. This will create signalling overhead in the network. Requested NSSAI is used in RAN to apply RAN based allocation of slicing resources to the UE. If the Requested NSSAI is not available at RAN, then RAN cannot do RAN based allocation of resources during the AS signalling connection establishment.

In view of the problems described above, the present disclosure aims to provide a solution to solve at least one of the various problems.

### Solution to Problem

In a first aspect of the present disclosure, a mobile communication system is provided, the mobile communication system including a user equipment (UE) configured to obtain an access stratum (AS) security context of the UE, encrypt a first message or sensitive information element (IE) included in the first message containing Network Slice Selection Assistance Information (NSSAI) using the AS security context, and send the first message; and a radio access network (RAN) node configured to obtain the AS security context, receive the first message from the UE, decrypt the first message or the sensitive IE using the AS security context, and obtain the NSSAI.

In a second aspect of the present disclosure, a mobile communication system is provided, the mobile communication system including a user equipment (UE) configured to obtain an access stratum (AS) security context of the UE, encrypt a first message or sensitive information element (IE) included in the first message containing Network Slice Selection Assistance Information (NSSAI) using the AS security context, and send the first message; a first core network node configured to receive the first message from the UE, decrypt the first message or the sensitive IE using the AS security context, and send a second message including the AS security context and the decrypted part of the first message or the decrypted first message; and a radio access network (RAN) node configured to receive the second message from the first core network node, and obtain the AS security context and the NSSAI.

In a third aspect of the present disclosure, a communication method for a user equipment (UE) is provided, the communication method including receiving, from a radio access network (RAN) node, an access stratum (AS) security context of the UE, encrypting a first message or sensitive information element (IE) included in the first message containing Network Slice Selection Assistance Information (NSSAI) using the AS security context, and sending, to the RAN node, the first message.

In a fourth aspect of the present disclosure, a communication method for a radio access network (RAN) node is provided, the communication method including transmitting, to a user equipment (UE), an access stratum (AS) security context of the UE, and receiving, from the UE, a first message or sensitive information element (IE) included in the first message containing Network Slice Selection Assistance Information (NSSAI) encrypted by using the AS security context.

In a fifth aspect of the present disclosure, a user equipment (UE) is provided, the UE including a transceiver circuit and a controller, wherein the controller configured to receive, from a radio access network (RAN) node, an access stratum (AS) security context of the UE, encrypt a first message or sensitive information element (IE) included in the first message containing Network Slice Selection Assistance Information (NSSAI) using the AS security context, and send, to the RAN node, the first message.

In a sixth aspect of the present disclosure, a radio access network (RAN) node is provided, the RAN node including a transceiver circuit and a controller, wherein the controller configured to transmit, to a user equipment (UE), an access stratum (AS) security context of the UE, and receive, from the UE, a first message or sensitive information element (IE) included in the first message containing Network Slice Selection Assistance Information (NSSAI) encrypted by using the AS security context.

### BRIEF DESCRIPTION OF DRAWINGS

FIG. 1 illustrates a signalling flow according to a first aspect.

FIG. 2 illustrates a signalling flow according to a second aspect.

FIG. 3 illustrates a signalling flow according to a third aspect.

FIG. 4 illustrates a signalling flow of a fourth aspect.

FIG. 5 illustrates a signalling flow according to a fifth aspect.

FIG. 6 is a block diagram showing a configuration example of a UE.

FIG. 7 is a block diagram showing a configuration example of a (R)AN.

FIG. 8 is a block diagram showing a configuration example of an AMF.

### DESCRIPTION OF EMBODIMENTS

Abbreviations

For the purposes of the present disclosure, the abbreviations given in 3GPP TR 21.905 (NPL1) and the following are applied. An abbreviation defined in the present disclosure takes precedence over the definition of the same abbreviation, if any, in 3GPP TR 21.905 (NPL1).

### 5GC 5G Core Network

### 5GS 5G System

### 5G-AN 5G Access Network

### 5G-GUTI 5G Globally Unique Temporary Identifier

### 5G S-TMSI 5G S-Temporary Mobile Subscription Identifier

### 5QI 5G QoS Identifier

### AF Application Function

### AMF Access and Mobility Management Function

### AN Access Node

### AS Access Stratum

### AUSF Authentication Server Function

### CM Connection Management

### CP Control Plane

### CSFB Circuit Switched (CS) Fallback

### DL Downlink

### DN Data Network

### DNAI DN Access Identifier

### DNN Data Network Name

### EDT Early Data Transmission

### EPS Evolved Packet System

### EPC Evolved Packet Core

### FQDN Fully Qualified Domain Name

### GFBR Guaranteed Flow Bit Rate

### GMLC Gateway Mobile Location Centre

### GPSI Generic Public Subscription Identifier

### GUAMI Globally Unique AMF Identifier

HR Home Routed (roaming)

### I-RNTI I-Radio Network Temporary Identifier

### LADN Local Area Data Network

LBO Local Break Out (roaming)

### LMF Location Management Function

### LRF Location Retrieval Function

### MAC Medium Access Control

### MFBR Maximum Flow Bit Rate

### MICO Mobile Initiated Connection Only

### MME Mobility Management Entity

### N3IWF Non-3GPP Inter Working Function

### NAI Network Access Identifier

### NAS Non-Access Stratum

### NEF Network Exposure Function

### NF Network Function

### NG-RAN Next Generation Radio Access Network

### NR New Radio

### NRF Network Repository Function

### NSI ID Network Slice Instance Identifier

### NSSAI Network Slice Selection Assistance Information

### NSSF Network Slice Selection Function

### NSSP Network Slice Selection Policy

### NWDAF Network Data Analytics Function

### PCF Policy Control Function

### PEI Permanent Equipment Identifier

### PER Packet Error Rate

### PFD Packet Flow Description

PLMN Public land mobile network

### PPD Paging Policy Differentiation

### PPI Paging Policy Indicator

### PSA PDU Session Anchor

### QFI QoS Flow Identifier

### QoE Quality of Experience

### (R)AN (Radio) Access Network

### RLC Radio Link Control

### RM Registration Management

### RQA Reflective QoS Attribute

### RQI Reflective QoS Indication

### RRC Radio Resource Control

### SA NR Standalone New Radio

### SBA Service Based Architecture

### SBI Service Based Interface

### SD Slice Differentiator

### SDAP Service Data Adaptation Protocol

### SEAF Security Anchor Functionality

### SEPP Security Edge Protection Proxy

### SMF Session Management Function

### S-NSSAI Single Network Slice Selection Assistance Information

### SSC Session and Service Continuity

### SST Slice/Service Type

### SUCI Subscription Concealed Identifier

### SUPI Subscription Permanent Identifier

### UAC Unified Access Control

### UDSF Unstructured Data Storage Function

### UL Uplink

### UL CL Uplink Classifier

### UPF User Plane Function

### UDR Unified Data Repository

### URSP UE Route Selection Policy

### SMS Short Message Service

### SMSF SMS Function

### MT Mobile Terminated

### UAC Unified Access Control

### ODACD Operator Defined Access Category Definitions

### OS Operating System

### MO Mobile Originated

### MT Mobile Terminated

### USIM Universal Subscriber Identity Module

UICC Universal integrated circuit card

### SIB System Information Block

### Definitions

For the purposes of the present disclosure, the terms and definitions given in 3GPP TR 21.905 (NPL1) and the NPL2 to the NPL6 are applied. A term defined in the present disclosure takes precedence over the definition of the same term, if any, in 3GPP TR 21.905 (NPL1).

First Aspect (Solution 1 to Solve Problem Statement):

A first aspect includes fetching the AS security parameter from the Core Network by NG-RAN, and sending it to the UE to encrypt the sensitive information.

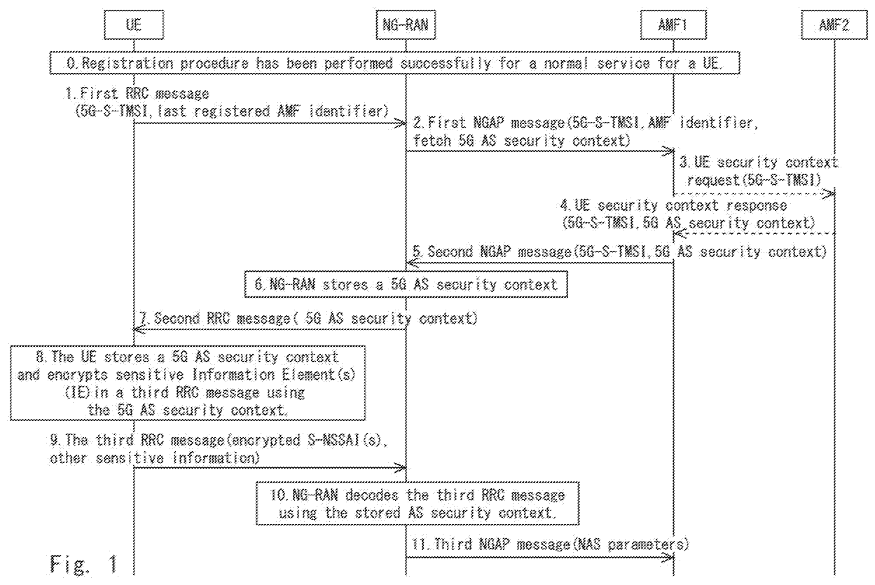

FIG. 1 shows the signalling flow of the solution 1.

In order to perform the solution 1, a UE should know NG-RAN capability on supporting solution 1 procedure. This can be realized by two ways below.
NG-RAN broadcasts its capability over the BCCH. The NG-RAN broadcasts an information that indicates a support of AS security as described in solution 1.
NG-RAN indicates its capability in the PRACH response message over the PRACH. Before step 1 takes place, NG-RAN sends an information that indicates a support of AS security as described in solution 1 as the response to the PRACH preamble message from the UE.

The detailed steps of solution 1 are given below.

0. A UE has performed a registration procedure for a normal service successfully to a network. The UE and the network establish a 5G Non-Access Stratum (NAS) Security context. The network optionally establishes a 5G Access Stratum security context.

1. The UE in 5GMM-IDLE state initiates an NAS signalling connection establishment procedure. As a part of the NAS signalling connection procedure, the UE first initiates establishment of AS signalling connection (e.g. RRC Connection) by sending an unencrypted first RRC message containing at least one of a UE temporary identity or an AMF identifier identifying a registered AMF or RRC establishment cause.

Inclusion of a UE temporary identity or an AMF identifier or RRC establishment cause can be interpreted by the NG-RAN that the NG-RAN needs to contact to an AMF in order to retrieve an AS security context.

In one example, the UE temporary identifier may be 5G-S-TMSI. The AMF identifier may include at least one of the registered PLMN identity (MCC and MNC) or an AMF identifier. The AMF identifier may be an AMF Region ID, an AMF Set ID and an AMF Pointer.

In one example, when the NG-RAN is gNB connected to a 5GC, the first RRC message may be an RRC Setup Request message, an RRC Reestablishment Request message or an RRC Resume Request message.

In one example, when the NG-RAN is ng-eNB connected to a 5GC, the first RRC message may be an RRC Connection Request message, an RRC Connection Reestablishment Request message or an RRC Connection Resume Request message.

2. The NG-RAN, on receiving the first RRC message, sends a first NGAP message to the registered AMF (e.g. AMF identified by the registered PLMN identity+AMF Identifier received from the UE) requesting the AMF to send the AS security context of the UE to the NG-RAN.

In case that the NG-RAN does not have a reachability to an AMF that is received for the UE as the registered AMF, then the NG-RAN may choose an arbitrary AMF and sends the first NGAP message.

In one example, the first NGAP message may be an Initial UE message or a known NGAP message or a new NGAP message.

3. Depending upon a value of the registered PLMN identity+AMF Identifier which are received in the first NGAP message, the AMF1 might send the UE security context request message to an AMF2 to fetch a 5G AS security context. The UE security context request message includes the 5G S-TMSI that is received in the message number 2. The AMF2 is chosen by the AMF1 based on contents of the 5G S-TMSI or the registered AMF identifier and the registered PLMN identity. This message can be Namf_Communication_UEContextTransfer or Nudsf_Unstructured Data Management_Query or a new message.

4. The AMF2 sends the UE security context response message to the AMF1. The UE security context response message includes the 5G AS security context.

This message can be a response to the Namf_Communication_UEContextTransfer or a response to the Nudsf_Unstructured Data Management_Query or the new message.

5. The AMF1, on receiving the UE security context response message containing the 5G-S-TMSI, identifies the UE security context in the AMF2 corresponding to the UE temporary identifier (e.g. 5G-S-TMSI). Or the AMF1 obtains the 5G AS security context by receiving the message number 4.

The AMF1 sends a second NGAP message to the NG-RAN including the 5G AS security context of the UE.

In one example, the second NGAP message may be an Initial Context Setup message or a known NGAP message.

6. The NG-RAN stores the 5G AS security context of the UE.

7. The NG-RAN sends the 5G AS security context and a radio bearer configuration of SRB 1 to the UE in a second RRC message. The second RRC message is sent one of the following ways:

i) The second RRC message is sent with ciphering. The 5G AS security context is not ciphered.

ii) The second RRC message is sent without ciphering.

In one example, when the NG-RAN is gNB connected to a 5GC, the second RRC message may be an RRC Setup message, an RRC Reestablishment message or an RRC Resume message.

In one example, when the NG-RAN is ng-eNB connected to a 5GC, the second RRC message may be an RRC Connection Setup message, an RRC Connection Reestablishment message or an RRC Connection Resume message.

8. When the UE receives the second RRC message, it stores the 5G AS security context.

9. The UE sends a third RRC message. An information element(s) in the third RRC message is encrypted.

The RRC layer in the UE may inform an upper layer indicating that the third RRC message in solution 1 can be AS security enabled. With this indication the upper layer in the UE may build up a NAS message with parameters that are required to be secured. For example, the NAS message on the third RRC message may have SUPI, (S-)NSSAI, MSISDN or IMEISV.

In one example, the UE ciphers the third RRC message using the 5G AS security.

In one example, the UE ciphers only sensitive information element(s) (e.g. S-NSSAI (s) and other IEs).

In one example, when the NG-RAN is gNB connected to a 5GC, the third RRC message may be an RRC Setup Complete message, an RRC Reestablishment Complete message or an RRC Resume Complete message.

In one example, when the NG-RAN is ng-eNB connected to a 5GC, the third RRC message may be an RRC Connection Setup Complete message, an RRC Connection Reestablishment Complete message or an RRC Connection Resume Complete message.

10. The NG-RAN decrypts the IE(s) using the stored the 5G AS security context. After the IE(s) is decrypted, the NG-RAN takes action depending on the decrypted IE(s) and the current situation in the NG-RAN.

When an RRC connection is released, the UE and the NG-RAN delete the 5G AS security context, i.e. does not use the stored security context.

11. The NG-RAN sends a third NGAP message to the AMF1.

In one example, the third NGAP message may be an Initial Context Setup message or a known NGAP message.

The UE and the network will follow steps 1 to 11 when a new RRC connection establishment procedure is initiated.

In one example, the UE and the NG-RAN maintain the 5G AS security context. The UE and the NG-RAN use the 5G AS Security context to encrypt and decrypt the RRC messages during the subsequent RRC establishment procedure.

In one example the 5G AS security context may include at least one of the elements: AS level with their identifiers, the Next Hop parameter (NH), the Next Hop Chaining Counter parameter (NCC) used for next hop access key derivation, the identifiers of the selected AS level cryptographic algorithms, the UP Security Policy at the network side, and the counters used for replay protection.

In one example the 5G NAS security context may include at least one of the key KAMF with the associated key set identifier, the UE security capabilities, or the uplink and downlink NAS COUNT values.

In one example when the UE has a valid 5G-GUTI, then the NAS layer always give AS layer a 5G-GUTI. The AS layer uses the 5G-GUTI to derive the 5G-S-TMSI and the registered AMF identifier.

Alternatively, in one example, the NG-RAN may broadcast an AMF list including the one or more AMF identifiers and indicating a list of AMF(s) to which the NG-RAN should or may send the first NGAP message. In this case, the UE may receive the broadcasted AMF list, set one or more AMF identifiers among the AMF list into the first RRC message and transmit the first RRC message to the NG-RAN. The NG-RAN sends the first NGAP message to the AMF indicated by the one AMF identifier included in the first RRC message. In this example, the above mentioned step 0 may not be essential. In other words, in this example, the AMF identifier may not identify the registered AMF.

Here, the AMF list may be broadcasted by Minimum SI (System Information). The Minimum SI includes at least one of MIB (Master Information Block) and SIB1 (System Information Block type1). Alternatively or in addition, the AMF list may be broadcasted by Other SI (e.g. SIB2, SIB3, SIB4, . . . SIB9). Therefore, the AMF list may be broadcasted upon request by the UE.

Second Aspect (Solution 2 to Solve Problem Statement):

A second aspect includes fetching the AS security parameter from the Core Network by NG-RAN, and using it for decrypting the encrypted an Access Stratum Information Element.

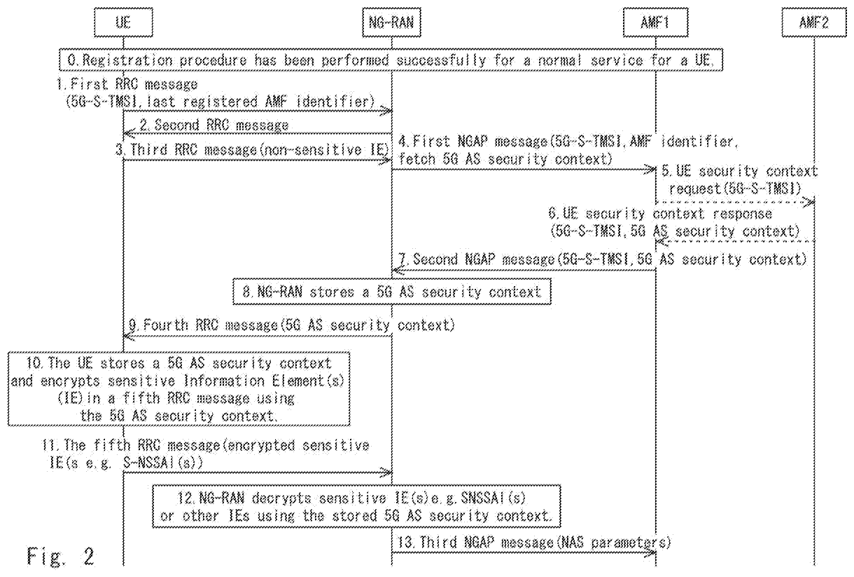

FIG. 2 shows the signalling flow of the solution 2.

In order to perform the solution 2, a UE should know NG-RAN capability on supporting solution 2 procedure. This can be realized by two ways below.
NG-RAN broadcasts its capability over the BCCH. The NG-RAN broadcasts an information that indicates a support of AS security as described in solution 2.
NG-RAN indicates its capability in the PRACH response message over the PRACH. Before step 1 takes place, NG-RAN sends an information that indicates a support of AS security as described in solution 2 as the response to the PRACH preamble message from the UE.

The detailed steps of solution 2 are given below.

0. A UE has performed a registration procedure for a normal service successfully to a network. The UE and the network establish a 5G Non-Access Stratum (NAS) Security context. The network optionally establishes a 5G Access Stratum security context.

1. The UE in 5GMM IDLE state initiates an NAS signalling connection establishment procedure. As a part of the NAS signalling connection procedure, the UE initiates establishment of AS signalling connection by sending an unencrypted First RRC message including a UE temporary identity.

In one example the UE temporary identifier may be 5G-S-TMSI.

In one example, when the NG-RAN is gNB connected to a 5GC, the first RRC message may be an RRC Setup Request message, an RRC Reestablishment Request message or an RRC Resume Request message.

In one example, when the NG-RAN is ng-eNB connected to a 5GC, the first RRC message may be an RRC Connection Request message, an RRC Connection Reestablishment Request message or an RRC Connection Resume Request message

2. The NG-RAN sends the UE in a second RRC message containing radio bearer configuration of SRB 1.

In one example, when the NG-RAN is gNB connected to a 5GC, the second RRC message may be an RRC Setup message, an RRC Reestablishment message or an RRC Resume message.

In one example, when the NG-RAN is ng-eNB connected to a 5GC, the second RRC message may be an RRC Connection Setup message, an RRC Connection Reestablishment message or an RRC Connection Resume message.

3. The UE sends a third RRC message in response of the second RRC message. The third RRC message does not contain a sensitive IE (e.g. S-NSSAI). The third RRC message contains the UE temporary identity or the AMF identifier of the registered AMF.

Inclusion of a UE temporary identity or an AMF identifier or RRC establishment cause can be interpreted by the NG-RAN that the NG-RAN needs to contact to an AMF in order to retrieve an AS security context.

In one example the UE temporary identifier may be 5G-S-TMSI. The AMF identifier may include at least one of the registered PLMN identity (MCC and MNC) or an AMF identifier. The AMF identifier may be an AMF Region ID, an AMF Set ID and an AMF Pointer.

In one example, when the NG-RAN is gNB connected to a 5GC, the third RRC message may be an RRC Setup Complete message, an RRC Reestablishment Complete message or an RRC Resume Complete message.

In one example, when the NG-RAN is ng-eNB connected to a 5GC, the third RRC message may be an RRC Connection Setup Complete message, an RRC Connection Reestablishment Complete message or an RRC Connection Resume Complete message.

4. The NG-RAN, on receiving the third RRC message, sends a first NGAP message to the registered AMF requesting the AMF to send the AS security context of the UE to the NG-RAN.

In case that the NG-RAN does not have a reachability to an AMF that is received for the UE as the registered AMF, then the NG-RAN may choose an arbitrary AMF and sends the first NGAP message.

In one example, the first NGAP message may be an Initial UE message or a known NGAP message.

5. Depending upon a value of the received 5G S-TMSI in the first NGAP message, the AMF1 might send the UE security context request message to an AMF2 to fetch a 5G AS security context. The UE security context request message includes the 5G S-TMSI that is received in the message number 2. The AMF2 is chosen by the AMF1 based on contents of the 5G S-TMSI or the registered AMF identifier and the registered PLMN. This message can be Namf_Communication_UEContextTransfer or Nudsf_Unstructured Data Management_Query.

6. The AMF2 sends the UE security context response message to the AMF1. The UE security context response message includes the 5G AS security context.

This message can be a response to the Namf_Communication_UEContextTransfer or a response to the Nudsf_Unstructured Data Management_Query.

7. The AMF1, on receiving the UE security context response message containing the 5G-S-TMSI, identifies the UE security context in the AMF2 corresponding to the UE temporary identifier (e.g. 5G-S-TMSI). Or the AMF1 obtains the 5G AS security context by receiving the message number 6. The AMF1 sends a second NGAP message to the NG-RAN including the 5G AS security context of the UE.

In one example, the second NGAP message may be an Initial Context Setup message or a known NGAP message.

8. The NG-RAN stores the 5G AS security context of the UE.

9. The NG-RAN sends a fourth RRC message containing the 5G AS security context to the UE.

10. The UE stores the 5G AS security context.

The RRC layer in the UE may inform an upper layer indicating that the third RRC message in solution 2 can be AS security enabled. With this indication the upper layer in the UE may build up a NAS message with parameters that are required to be secured. For example, the NAS message on the third RRC message may have SUPI, (S-)NSSAI, MSISDN or IMEISV.

11. The UE sends a third RRC message to the NG-RAN. The UE performs one of the following steps:

i) Encrypts the fifth RRC message and send it to the NG-RAN.

ii) Encrypts only sensitive IE(s) (e.g. S-NSSAI(s)) and sends the encrypted sensitive IE(s) in the fifth RRC message.

12. Upon receiving the fifth RRC message, the NG-RAN performs one of the following steps:

i) decrypts the fifth RRC message if the RRC message was ciphered and get the sensitive IE(s).

ii) decrypts the encrypted IE(s) when sensitive IE(s) are encrypted.

13. The NG-RAN sends a third NGAP message to the AMF1.

In one example, the third NGAP message may be an Initial Context Setup message or a known NGAP message.

When the UE goes to 5GMM-IDLE state i.e. when the RRC connection is released, then the UE and NG-RAN delete the 5G AS security.

The UE and the network will follow steps 1-13 when a new RRC connection establishment procedure is initiated.

In one example, the UE and the NG-RAN maintain the 5G AS security context. The UE and the NG-RAN use the 5G AS Security context to encrypts and decrypt the RRC messages during the subsequent RRC establishment procedure.

The forth RRC message is a SECURITY MODE COMMAND message or an existing RRC message or a new RRC message. The fifth RRC message is a SECURITY MODE COMPLETE message or an existing RRC message or a new RRC message.

In one example, the 5G AS security context may include at least one of the element: AS level with their identifiers, the Next Hop parameter (NH), the Next Hop Chaining Counter parameter (NCC) used for next hop access key derivation, the identifiers of the selected AS level cryptographic algorithms, the UP Security Policy at the network side, and the counters used for replay protection.

In one example, the 5G NAS security context may include at least one of the key KAMF with the associated key set identifier, the UE security capabilities, or the uplink and downlink NAS COUNT values.

In one example, when the UE has a valid 5G-GUTI, then the NAS layer always give AS layer a 5G-GUTI. The AS layer uses the 5G-GUTI to derive the 5G-S-TMSI and the registered AMF identifier.

Alternatively, in one example, the NG-RAN may broadcast or transmit, by dedicated signalling, an AMF list including the one or more AMF identifiers and indicating a list of AMF(s) to which the NG-RAN should or may send the first NGAP message. In this case, the UE may receive the AMF list, set one or more AMF identifiers among the AMF list into the third RRC message and transmit the third RRC message to the NG-RAN. The NG-RAN sends the first NGAP message to the AMF indicated by the one AMF identifier included in the third RRC message. In this example, the above mentioned step 0 may not be essential. In other words, in this example, the AMF identifier may not identify the registered AMF.

Here, the AMF list may be broadcasted by Minimum SI (System Information). The Minimum SI includes at least one of MIB (Master Information Block) and SIB1 (System Information Block type1). Alternatively or in addition, the AMF list may be broadcasted by Other SI (e.g. SIB2, SIB3, SIB4, . . . SIB9). Therefore, the AMF list may be broadcasted upon request by the UE.

Third Aspect (Solution 3 to Solve Problem Statement):

In a third aspect, Core network provides the AS security context to the UE and the NG-RAN fetches the security context from the Core Network during the RRC Connection establishment procedure.

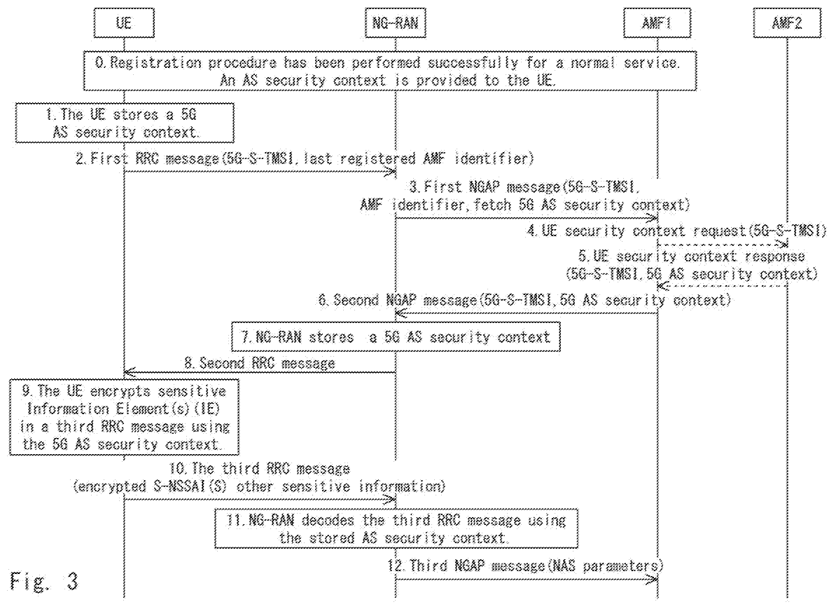

FIG. 3 shows the signalling flow of the solution 3.

In order to perform the solution 3, a UE should know NG-RAN capability on supporting solution 3 procedure. This can be realized by two ways below.
NG-RAN broadcasts its capability over the BCCH. The NG-RAN broadcasts an information that indicates a support of AS security as described in solution 3.
NG-RAN indicates its capability in the PRACH response message over the PRACH. Before step 2 takes place, NG-RAN sends an information that indicates a support of AS security as described in solution 3 as the response to the PRACH preamble message from the UE.

The detailed steps of solution 3 are given below.

0. A UE has performed a registration procedure for a normal service successfully to a network. The UE and the network establish a 5G Non-Access Stratum (NAS) Security context and a 5G Access Stratum security context. The network provides the AS security context to the UE during the registration procedure.

The 5G AS security context is provided to the UE in one of the following NAS message:

i) in the registration accept message;

ii) in the Security Mode Command message;

iii) in an existing NAS message; or

iv) in a new NAS message.

1. The UE stores the 5G AS security context.

2. The UE in 5GMM IDLE state initiates an NAS signalling connection establishment procedure. The UE initiates establishment of AS signalling connection by sending an unencrypted First RRC message containing a UE temporary identity or an AMF identifier of registered AMF.

Inclusion of a UE temporary identity or an AMF identifier or RRC establishment cause can be interpreted by the NG-RAN that the NG-RAN needs to contact to an AMF in order to retrieve an AS security context.

In one example, the UE temporary identifier consists of 5G-S-TMSI.

3. The NG-RAN, on receiving the first RRC message, sends a first NGAP message containing the UE temporary identity 5G-S-TMSI to the registered AMF of the UE requesting the AMF to send the AS security context of the UE to the NG-RAN. The AMF identifies the registered AMF of the UE using the AMF identifier received in the first RRC message.

In case that the NG-RAN does not have a reachability to an AMF that is received for the UE as the registered AMF, then the NG-RAN may choose an arbitrary AMF (e.g. Default AMF) and sends the first NGAP message.

In one example, the first NGAP message may be an Initial UE message or a known NGAP message or a new NGAP message.

4. Depending upon a value of the received 5G S-TMSI or the registered AMF identifier and the registered PLMN in the first NGAP message, the AMF1 might send the UE security context request message to an AMF2 to fetch a 5G AS security context. The UE security context request message includes the 5G S-TMSI that is received in the message number 3. The AMF2 is chosen by the AMF1 based on contents of the 5G S-TMSI or the registered PLMN and the registered AMF identifier. This message can be Namf_Communication_UEContextTransfer or Nudsf_Unstructured Data Management_Query or a new message.

5. The AMF2 sends the UE security context response message to the AMF1. The UE security context response message includes the 5G AS security context.

This message can be a response to the Namf_Communication_UEContextTransfer or a response to the Nudsf_Unstructured Data Management_Query or a new message.

6. The AMF1, on receiving the UE security context response message containing 5G-S-TMSI, identifies the UE security context in the AMF2 corresponding to the UE temporary identifier (e.g. 5G-S-TMSI). Or the AMF1 obtains the 5G AS security context by receiving the message number 5.

The AMF1 sends a second NGAP message to the NG-RAN including the 5G AS security context of the UE.

In one example, the second NGAP message may be an Initial Context Setup message or a known NGAP message.

7. The NG-RAN stores the 5G AS security context of the UE.

8. The NG-RAN sends a second RRC message containing radio bearer configuration of the SIB 1.

9. On receiving the second RRC message, the UE performs one of the following steps:

i) encrypts the third RRC message containing sensitive IEs (S-NSSAI(s) or non-sensitive IE(s) using the stored 5G AS security context in step 1.

ii) encrypts only sensitive IE(s) (e.g. S-NSSAI(s) using the stored 5G AS security context in step 1.

10. The UE sends a third RRC message to the NG-RAN. An information element(s) in the third RRC message is encrypted as described in step 9.

11. Upon receiving the third RRC message, the NG-RAN performs one of the following steps:

i) decrypts the third RRC message if the third RRC message was ciphered and get the sensitive IE(s).

ii) decrypts the encrypted IE(s) of the third RRC message when only sensitive IE(s) are encrypted.

12. The NG-RAN sends a third NGAP message to the AMF1.

In one example, the third NGAP message may be an Initial Context Setup message or a known NGAP message or a new NGAP message.

When the UE goes to 5GMM IDLE mode i.e. when the RRC Connection is released, then the NG-RAN deletes the 5G AS security and the UE keeps 5G AS security context.

The UE and the network will follow steps 2-12 when a new RRC connection establishment procedure is initiated.

In one example, the UE and the NG-RAN maintain the 5G AS security context. The UE and the NG-RAN use the 5G AS Security context to encrypt and decrypt the RRC messages during the subsequent RRC establishment procedure.

When the NG-RAN is ng-eNB connected to a 5GC, the first RRC message is an RRC Connection Request message, the second RRC message is an RRC Connection setup message and the third RRC message is an RRC Connection setup complete message.

In one example, the 5G AS security context consists of at least one of the element: AS level with their identifiers, the Next Hop parameter (NH), the Next Hop Chaining Counter parameter (NCC) used for next hop access key derivation, the identifiers of the selected AS level cryptographic algorithms, the UP Security Policy at the network side, and the counters used for replay protection.

In one example, the 5G NAS security context consists of at least one of the key KAMF with the associated key set identifier, the UE security capabilities, or the uplink and downlink NAS COUNT values.

In one example, when the UE has a valid 5G-GUTI, then the NAS layer always give AS layer a 5G-GUTI. The AS layer uses the 5G-GUTI to derive 5G-S-TMSI and registered AMF identifier.

Forth Aspect (Solution 4 to Solve Problem Statement):

In a fourth aspect, a 5GC provides the AS security context to the UE and the NG-RAN sends an encrypted RRC IE(s) or an RRC message to a AMF to decrypt the encrypted RRC IE(s) or the RRC message.

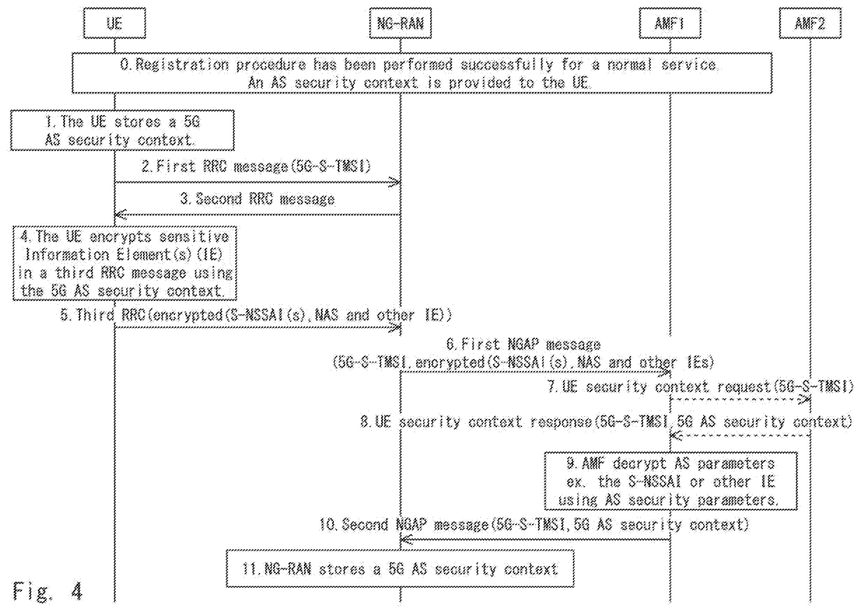

FIG. 4 shows the signalling flow of the solution 4.

In order to perform the solution 4, a UE should know NG-RAN capability on supporting solution 4 procedure. This can be realized by two ways below.
NG-RAN broadcasts its capability over the BCCH. The NG-RAN broadcasts an information that indicates a support of AS security as described in solution 4.
NG-RAN indicates its capability in the PRACH response message over the PRACH. Before step 2 takes place, NG-RAN sends an information that indicates a support of AS security as described in solution 4 as the response to the PRACH preamble message from the UE.
NG-RAN indicates its capability in the step 3.

The detailed steps of solution 4 are as described below.

0. A UE has performed a registration procedure for a normal service successfully to a network. The UE and the network establish a 5G Non-Access Stratum (NAS) Security context during registration procedure. The network provides the AS security context to the UE during the registration procedure.

The 5G AS security context is provided to the UE in one of the following NAS message:

i) in the registration accept message;

ii) in the Security Mode Command message;

iii) in an existing NAS message; or

iv) in a new NAS message.

1. The UE stores the 5G AS security context.

2. The UE in 5GMM-IDLE state initiates an NAS signalling connection establishment procedure. As a part of the NAS signalling connection procedure, the UE initiates establishment of AS signalling connection by sending an unencrypted First RRC message containing a UE temporary identity.

In one example the UE temporary identifier consists of 5G-S-TMSI.

3. Upon receiving the first RRC message, the NG-RAN sends a second RRC message containing radio bearer configuration of SIB 1.

4. On receiving the second RRC message, the UE performs one of the following steps:

i) Encrypts the third RRC message containing sensitive IE(s) (e.g. (S-NSSAI(s)) or other IE(s)) using the 5G AS security context.

ii) Encrypts only sensitive IE(s) (e.g. S-NSSAI(s) using the 5G AS security context.

In one example the NG-RAN also includes 5G-S-TMSI in the second NGAP message.

5. The UE sends the third RRC message containing at least one of the encrypted sensitive IE(s) (e.g. S-NSSAI(s)), NAS PDU and non-sensitive IE(s) to the network.

6. Upon receiving the third RRC message, the NG-RAN performs one of the following steps:

i) Sends a First NGAP message to the AMF1 containing 5G-S-TMSI and the third RRC message that was received in the step 5.

ii) Sends the first NGAP message to the AMF1 containing 5G-S-TMSI and the encrypted IE(s) that were received in the third RRC message.

7. Depending upon a value of the received 5G S-TMSI in the first NGAP message, the AMF1 might send the UE security context request message to an AMF2 to fetch a 5G AS security context. The UE security context request message includes the 5G S-TMSI that is received in the message number 2. The AMF2 is chosen by the AMF1 based on contents of the 5G S-TMSI or the registered AMF identifier and the registered PLMN. This message can be Namf_Communication_UEContextTransfer or Nudsf_Unstructured Data Management_Query or a new message.

8. The AMF2 sends the UE security context response message to the AMF1. The UE security context response message includes the 5G AS security context.

This message can be a response to the Namf_Communication_UEContextTransfer or a response to the Nudsf_Unstructured Data Management_Query or a new message.

9. The AMF1, on receiving the UE security context response message containing 5G-S-TMSI, identifies the UE security context in the AMF2 corresponding to the UE temporary identifier (e.g. 5G-S-TMSI). Or the AMF1 obtains the 5G AS security context by receiving the message number 8.

The AMF1 performs one of the following steps:

i) Decrypts the encrypted part of the first NGAP message.

ii) Decrypts the third RRC message.

10. The AMF1 sends the second NGAP message to the NG-RAN with the decrypted part of the first NGAP message or the decrypted third RRC message.

In one example, the second NGAP message may be an Initial Context Setup message or a known NGAP message or a new NGAP message.

11. The NG-RAN stores the 5G AS security context of the UE. The NG-RAN uses the decrypted IEs to execute the NG-RAN procedure, for example overload control for network slice, as per specified in the 3GPP specifications.

When the UE goes to 5GMM IDLE mode i.e. when the RRC Connection is released, then the NG-RAN deletes the 5G AS security and the UE keeps 5G AS security context.

The UE and the network will follow steps 2-11 when a new RRC connection establishment procedure is initiated.

When the NG-RAN is ng-eNB connected to a 5GC, the first RRC message is an RRC Connection Request message or an RRC Connection Reestablishment Request message or an RRC Resume Request message, the second RRC message is an RRC Connection setup message or an RRC Connection Reestablishment and the third RRC message is an RRC Connection setup complete message or an RRC Connection Reestablishment complete message.

When the NG-RAN is gNB connected to a 5GC, the first RRC message is an RRC SETUP REQUEST, or an RRC Reestabishment Request, the second RRC message is RRC SETUP or an RRC Reestablishment message and the third RRC message is RRC SETUP COMPLETE message or RRC reestablishment complete message.

In one example the 5G AS security context consists of at least one of the element: AS level with their identifiers, the Next Hop parameter (NH), the Next Hop Chaining Counter parameter (NCC) used for next hop access key derivation, the identifiers of the selected AS level cryptographic algorithms, the UP Security Policy at the network side, and the counters used for replay protection.

In one example the 5G NAS security context consists of at least one of the key KAMF with the associated key set identifier, the UE security capabilities, or the uplink and downlink NAS COUNT values.

In one example, when the UE has a valid 5G-GUTI, then the NAS layer always give AS layer a 5G-GUTI. The AS layer uses the 5G-GUTI to derive 5G-S-TMSI and registered AMF identifier.

Fifth Aspect (Solution 5 to Solve Problem Statement):

In a fifth aspect, Core network provides the AS security context to the UE and to the NG-RAN during the registration procedure.

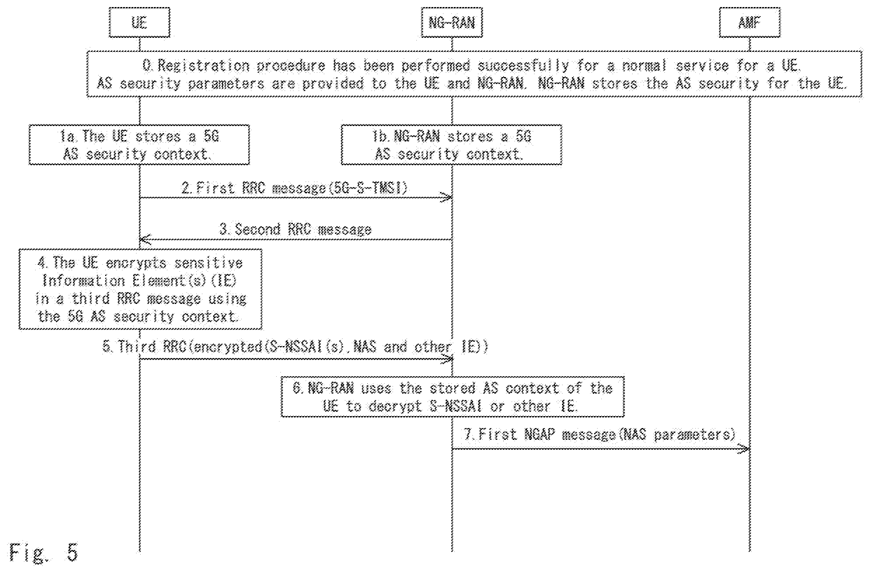

FIG. 5 shows the signalling flow of the solution 5.

The detailed steps of solution 5 are given below.

0. A UE has performed a registration procedure for a normal service successfully to a network. The UE and the network establish a 5G Non-Access Stratum (NAS) Security context. The network provides the AS security context to the UE and to the NG-RAN during the registration procedure.

The 5G AS security context is provided to the UE in one of the following NAS message:

i) In the registration accept message;

ii) In the Security Mode Command message;

iii) In an existing NAS message; or

iv) In a new NAS message.

The 5G-AS security context is provided to the NG-RAN in one of the following NAS message:

i) An existing NGAP message; or

ii) A new NGAP message.

1a. The UE stores the 5G AS security context.

1b. The NG-RAN stores the 5G AS security context.

2. The UE in 5GMM IDLE state initiates an NAS signalling connection establishment procedure. As a part of the NAS signalling connection procedure, the UE initiates establishment of AS signalling connection by sending an unencrypted First RRC message containing a UE temporary identity.

In one example, the UE temporary identifier consists of 5G-S-TMSI.

3. Upon receiving the first RRC message, the NG-RAN sends second RRC message containing radio bearer configuration for SIB 1.

4. On receiving the second RRC message, the UE performs one of the following steps:

i) Encrypts the third RRC message containing IEs (S-NSSAI(s) or other IE(s)) using the 5G AS security context that were stored in the step 1a.

ii) Encrypts only sensitive IE(s) (e.g. S-NSSAI(s) using the 5G AS security keys that were stored in the step 1a.

5. The UE sends the third RRC message to the NG-RAN.

6. Upon receiving the third RRC message, the NG-RAN performs one of the following steps:

i) Decrypts the third RRC message using the 5G AS security context that were stored in the step 1b if the RRC message was encrypted.

ii) Decrypts the encrypted IE(s) using the 5G AS security context that were stored in the step 1b in the third RRC message.

The NG-RAN uses the decrypted IEs to execute the NG-RAN procedure, for example overload control for network slice, as per specified in the 3GPP specifications

When the RRC connection is released, the UE and the NG-RAN maintain the UE 5G AS security context.

When the NG-RAN is ng-eNB connected to a 5GC, the first RRC message is an RRC Connection Request message or an RRC Reestablishment Request or an RRC Resume message, the second RRC message is an RRC Connection setup message or an RRC Reestablishment or an RRC Resume message and the third RRC message is an RRC Connection setup complete or an RRC Reestablishment Complete or an RRC Resume Complete message.

When the NG-RAN is gNB connected to a 5GC, the first RRC message is an RRC SETUP REQUEST message, or an RRC Reestablishment Request message or an RRC Resume Request message, the second RRC message is an RRC SETUP message or an RRC Reestablishment or an RRC Resume message and the third RRC message is an RRC SETUP COMPLETE message or an RRC Resume Complete message or an RRC Reestablishment Complete message.

In one example, the 5G AS security context consists of at least one of the element: AS level with their identifiers, the Next Hop parameter (NH), the Next Hop Chaining Counter parameter (NCC) used for next hop access key derivation, the identifiers of the selected AS level cryptographic algorithms, the UP Security Policy at the network side, and the counters used for replay protection.

In one example, the 5G NAS security context consists of at least one of the key KAMF with the associated key set identifier, the UE security capabilities, or the uplink and downlink NAS COUNT values.

In one example, when the UE has a valid 5G-GUTI, then the NAS layer always give AS layer a 5G-GUTI. The AS layer uses the 5G-GUTI to derive 5G-S-TMSI and the registered AMF identifier.

Sixth Aspect (Solution 6 to Solve Problem Statement):

1) For the solution 1 to 5, if a current cell where the UE is camped belongs to another registration area than the last registration area, then the NG-RAN sends 5G-GUTI (5G-S-TMSI and AMF Identifier) to a default AMF or an arbitrary AMF (e.g. default AMF) serving the current cell and requesting the default AMF or the arbitrary to fetch the 5G AS Security context from the registered AMF. In addition to the 5G AS security context, the NG-RAN may also request to fetch an additional context of the UE (e.g. access and mobility related parameters, NAS security parameters, ESM parameters).

2) The default AMF identifies a registered AMF based on the 5G-GUTI and sends a message containing the 5G-GUTI to the registered AMF requesting the AMF to send UE 5G AS security context and optionally other parameters as mentioned in the step 1).

3) The registered AMF identifies the UE context using 5G-GUTI and sends the 5G AS security context and optionally other UEs parameters in a message to the default AMF.

4) The default AMF, after getting the UE 5G AS security context, sends this to the UE or the NG-RAN as per the procedure defined in solution 1 to 5.

In solution 1 to 5, in one example, the UE may use the 5G NAS security context (e.g. when the UE has only 5G NAS security context) to encrypt the RRC message (e.g. the third RRC message in all the solution 1 to 5) containing the sensitive IE or the sensitive IE(s) itself in the RRC message (e.g. the third RRC message in all the solution 1 to 5).

In solution 1 to 5, the 5G AS security context is consists of at least home network public key, the Home Network Public Key Identifier and the Protection Scheme Identifier i.e. the parameters used to calculate SUCI from SUPI.

The registered AMF identifier is the AMF identifier of the latest AMF to which the UE has registration procedure successfully.

The registered PLMN is the latest PLMN to which the UE has performed Registration procedure successfully.

In one example, solution 1 to 5 will override an operator policy which prohibits the UE for sending sensitive information (e.g. S-NSSAI(s)) without security protected (e.g. without integrity or ciphering). That is, if the operator policy says not to send sensitive information during RRC connection establishment or send sensitive information without security protection, and the UE and network support solution 1 to 5, then the UE and the network follow the solution 1 to 5 and ignore the operator policy send to the network.

In one example, if the network and the UE support any one of solution 1 to 6, then the network does not send an operator policy requesting the UE not to send a sensitive IE(s) to the NG-RAN during the RRC connection establishment procedure.

In all solution 1 to 6 above, the UE optionally sends it capability to support AS level security protection using 5G AS security context or 5G NAS security context using to the NG-RAN or two AMF during a NAS procedure (e.g. during Registration procedure) or an RRC procedure (e.g. RRC Connection establishment procedure). In one example, the UE sends following capability to the NG-RAN or AMF separately:

i). UE supports security protection to the sensitive information(s) during RRC Connection establishment using a 5G AS security context.

ii). UE supports security protection to the sensitive information(s) during RRC Connection establishment using a 5G NAS security context.

iii) UE supports security protection to the sensitive information(s) during RRC Connection establishment using at least home network public key, the Home Network Public Key Identifier and the Protection Scheme Identifier.

In one example, in all solution 1 to 5, the encryption means ciphering.

In all solution 1 to 5, the sensitive information element means an user information or an UE capability that is protected against unwarranted disclosure. Access to sensitive information should be safeguarded. Protection of sensitive information may be required for legal or ethical reasons, for issues pertaining to personal privacy, or for proprietary considerations. The example is any information related to user permanent identity (e.g. SUPI) or services the user is accessing (e.g. S-NSSAIs).

Another Aspect

The User Equipment (or “UE”, “mobile station”, “mobile device” or “wireless device”) in the present disclosure is an entity connected to a network via a wireless interface.

It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery.

It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 1 (source: 3GPP TS 22.368 V14.0.1 (August 2017), Annex B, the contents of which are incorporated herein by reference). This list is not exhaustive and is intended to be indicative of some examples of machine type communication applications.

TABLE 1
Some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary aspects described in the present document. Needless to say, these technical ideas and aspects are not limited to the above-described UE and various modifications can be made thereto.

User Equipment (UE)

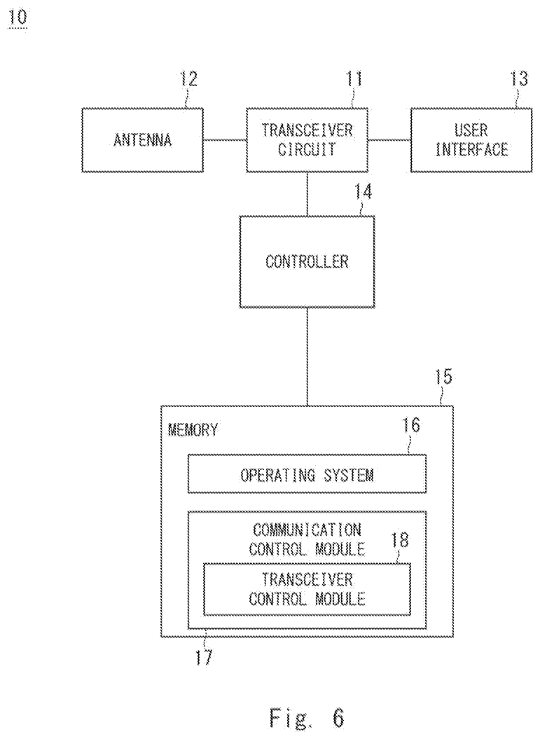

FIG. 6 is a block diagram illustrating the main components of the UE. As shown, the UE 10 includes a transceiver circuit 11 which is operable to transmit signals to and to receive signals from the connected node(s) via one or more antenna 12. Although not necessarily shown in FIG. 6, the UE 10 will of course have all the usual functionality of a conventional mobile device (such as a user interface 13) and this may be provided by any one or any combination of hardware, software and firmware, as appropriate. Software may be pre-installed in the memory and/or may be downloaded via the telecommunication network or from a removable data storage device (RMD), for example.

A controller 14 controls the operation of the UE 10 in accordance with software stored in a memory 15. For example, the controller 14 may be realized by Central Processing Unit (CPU). The software includes, among other things, an operating system 16 and a communications control module 17 having at least a transceiver control module 18. The communications control module 17 (using its transceiver control sub-module) is responsible for handling (generating/sending/receiving) signalling and uplink/downlink data packets between the UE 10 and other nodes, such as the base station/(R)AN node, a MME, the AMF (and other core network nodes). Such signalling may include, for example, appropriately formatted signalling messages relating to connection establishment and maintenance (e.g. RRC messages,), NAS messages such as periodic location update related messages (e.g. tracking area update, paging area updates, location area update) etc.

(R)AN Node

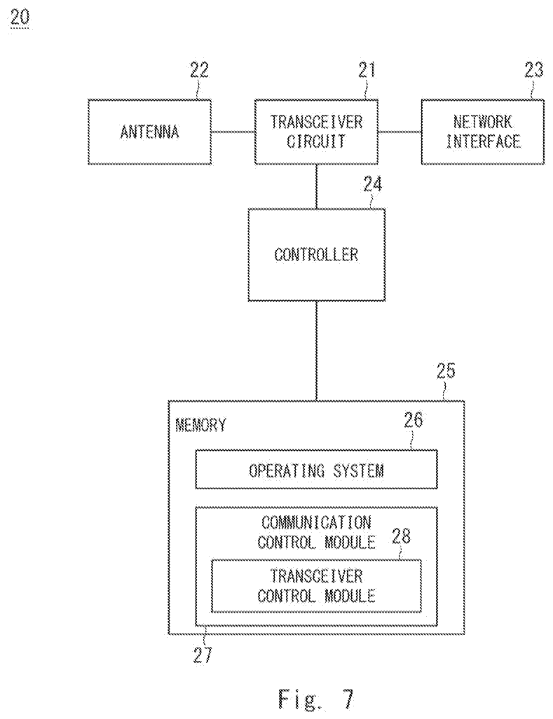

FIG. 7 is a block diagram illustrating the main components of an exemplary (R)AN node, for example a base station (′eNB′ in LTE, ‘ng-eNB’, ‘gNB’ in 5G). As shown, the (R)AN node 20 includes a transceiver circuit 21 which is operable to transmit signals to and to receive signals from connected UE(s) via one or more antenna 22 and to transmit signals to and to receive signals from other network nodes (either directly or indirectly) via a network interface 23. A controller 24 controls the operation of the (R)AN node 20 in accordance with software stored in a memory 25. For example, the controller 24 may be realized by Central Processing Unit (CPU). Software may be pre-installed in the memory 25 and/or may be downloaded via the telecommunication network or from a removable data storage device (RMD), for example. The software includes, among other things, an operating system 26 and a communications control module 27 having at least a transceiver control module 28.

The communications control module 27 (using its transceiver control sub-module) is responsible for handling (generating/sending/receiving) signalling between the (R)AN node 20 and other nodes, such as the UE, the MME, the AMF (e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller 24 is also configured (by software or hardware) to handle related tasks such as, when implemented, UE mobility estimate and/or moving trajectory estimation.

AMF

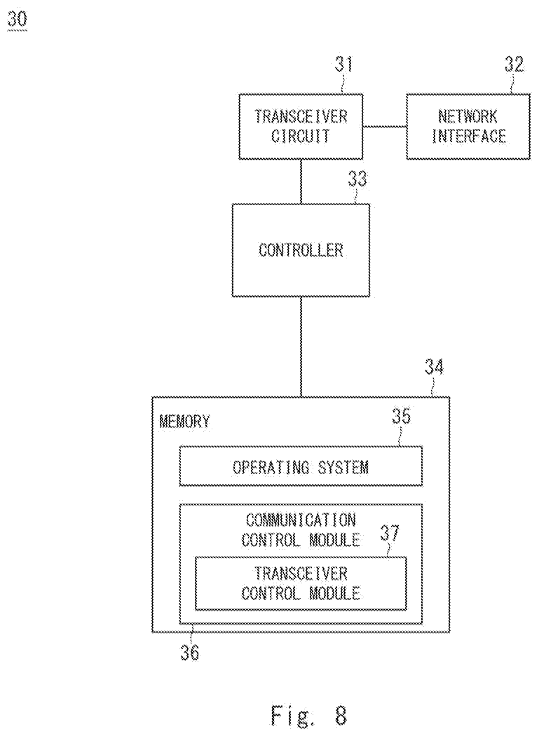

FIG. 8 is a block diagram illustrating the main components of the AMF. The AMF 30 is included in the 5GC. As shown, the AMF 30 includes a transceiver circuit 31 which is operable to transmit signals to and to receive signals from other nodes (including the UE) via a network interface 32. A controller 33 controls the operation of the AMF 30 in accordance with software stored in a memory 34. For example, the controller 33 may be realized by Central Processing Unit (CPU). Software may be pre-installed in the memory 34 and/or may be downloaded via the telecommunication network or from a removable data storage device (RMD), for example. The software includes, among other things, an operating system 35 and a communications control module 36 having at least a transceiver control module 37.

The communications control module 36 (using its transceiver control sub-module) is responsible for handling (generating/sending/receiving) signalling between the AMF and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

As will be appreciated by one of skill in the art, the present disclosure may be embodied as a method, and system. Accordingly, the present disclosure may take the form of an entirely hardware aspect, a software aspect or an aspect combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

For example, the whole or part of the above aspects can be described as, but not limited to, the following supplementary notes.

### (Supplementary Note 1)

A mobile communication system comprising:

a user equipment (UE) configured to obtain an access stratum (AS) security context of the UE, encrypt a first message or sensitive information element (IE) included in the first message containing Network Slice Selection Assistance Information (NSSAI) using the AS security context, and send the first message; and

a radio access network (RAN) node configured to obtain the AS security context, receive the first message from the UE, decrypt the first message or the sensitive IE using the AS security context, and obtain the NSSAI.

### (Supplementary Note 2)

The mobile communication system according to Supplementary Note 1, further comprising a first core network node,

wherein the UE sends a UE identifier of the UE to the first core network node via the RAN node, and obtains the AS security context included in a second message received from the RAN node,

wherein the first core network node fetches the AS security context based on the UE identifier, and sends a third message including the AS security context to the RAN node, and

wherein the RAN node obtains the AS security context included in the third message and sends the second message including the AS security context to the UE.

### (Supplementary Note 3)

The mobile communication system according to Supplementary Note 2, further comprising a second core network node configured to receive the UE identifier from the first core network node, and fetch the AS security context based on the UE identifier, and send the obtained AS security context,

wherein the AS security context included in the third message is fetched by the first core network node and the second core network node.

### (Supplementary Note 4)

The mobile communication system according to Supplementary Note 1,

wherein the UE obtains the AS security context provided by a core network.

### (Supplementary Note 5)

The mobile communication system according to Supplementary Note 4,

wherein the RAN node obtains the AS security context provided by the core network.

### (Supplementary Note 6)

A mobile communication system comprising:

a user equipment (UE) configured to obtain an access stratum (AS) security context of the UE, encrypt a first message or sensitive information element (IE) included in the first message containing Network Slice Selection Assistance Information (NSSAI) using the AS security context, and send the first message;

a first core network node configured to receive the first message from the UE, decrypt the first message or the sensitive IE using the AS security context, and send a second message including the AS security context and the decrypted part of the first message or the decrypted first message; and

a radio access network (RAN) node configured to receive the second message from the first core network node, and obtain the AS security context and the NSSAI.

### (Supplementary Note 7)

The mobile communication system according to Supplementary Note 6,

wherein the UE sends a UE identifier of the UE to the first core network node via the RAN node, and

wherein the first core network node fetches the AS security context based on the UE identifier.

### (Supplementary Note 8)

The mobile communication system according to Supplementary Note 7, further comprising a second core network node configured to receive the UE identifier from the first core network node, and fetch the AS security context of the UE based on the UE identifier, and send the obtained AS security context,

wherein the AS security context included in the second message is fetched by the first core network node and the second core network node.

### (Supplementary Note 9)

The mobile communication system according to any one of Supplementary Notes 5 to 8,

wherein the UE obtains the AS security context provided by a core network.

### (Supplementary Note 10)

A communication method for a user equipment (UE), the communication method comprising:

receiving, from a radio access network (RAN) node, an access stratum (AS) security context of the UE,

encrypting a first message or sensitive information element (IE) included in the first message containing Network Slice Selection Assistance Information (NSSAI) using the AS security context, and

sending, to the RAN node, the first message.

### (Supplementary Note 11)

The communication method according to Supplementary Note 10, further comprising:

transmitting, to the RAN node, an identifier of last registered core network node, wherein the RAN node uses the identifier for obtaining the AS security context.

### (Supplementary Note 12)

A communication method for a radio access network (RAN) node, the communication method comprising:

transmitting, to a user equipment (UE), an access stratum (AS) security context of the UE, and

receiving, from the UE, a first message or sensitive information element (IE) included in the first message containing Network Slice Selection Assistance Information (NSSAI) encrypted by using the AS security context.

### (Supplementary Note 13)

The communication method according to Supplementary Note 12, further comprising:

receiving, from the UE, an identifier of last registered core network node;

transmitting, to a core network node, the identifier; and

receiving, from the core network node, the AS context related to the identifier.

### (Supplementary Note 14)

A user equipment (UE) comprising:

a transceiver circuit and a controller,

wherein the controller configured to:

receive, from a radio access network (RAN) node, an access stratum (AS) security context of the UE,

encrypt a first message or sensitive information element (IE) included in the first message containing Network Slice Selection Assistance Information (NSSAI) using the AS security context, and

send, to the RAN node, the first message.

### (Supplementary Note 15)

A radio access network (RAN) node comprising:

a transceiver circuit and a controller,
wherein the controller configured to:
transmit, to a user equipment (UE), an access stratum (AS) security context of the UE, and

receive, from the UE, a first message or sensitive information element (IE) included in the first message containing Network Slice Selection Assistance Information (NSSAI) encrypted by using the AS security context.

This application is based upon and claims the benefit of priority from Indian patent applications No. 201811041578, filed on Nov. 2, 2018, the disclosure of which is incorporated herein in its entirety by reference.

### REFERENCE SIGNS LIST

10 UE
11 TRANSCEIVER CIRCUIT
12 ANTENNA
13 USER INTERFACE
14 CONTROLLER
15 MEMORY
16 OPERATING SYSTEM
17 COMMUNICATIONS CONTROL MODULE
18 TRANSCEIVER CONTROL MODULE
20 (R)AN NODE
21 TRANSCEIVER CIRCUIT
22 ANTENNA
23 NETWORK INTERFACE
24 CONTROLLER
25 MEMORY
26 OPERATING SYSTEM
27 COMMUNICATIONS CONTROL MODULE
28 TRANSCEIVER CONTROL MODULE
30 AMF
31 TRANSCEIVER CIRCUIT
32 NETWORK INTERFACE
33 CONTROLLER
34 MEMORY
35 OPERATING SYSTEM
36 COMMUNICATIONS CONTROL MODULE
37 TRANSCEIVER CONTROL MODULE

What is claimed is:

1. A mobile communication system comprising:
a user equipment (UE) configured to obtain an access stratum (AS) security context of the UE, encrypt a first message or sensitive information element (IE) included in the first message containing Network Slice Selection Assistance Information (NSSAI) using the AS security context, and send the first message; and
a radio access network (RAN) node configured to obtain the AS security context, receive the first message from the UE, decrypt the first message or the sensitive IE using the AS security context, and obtain the NSSAI.

2. The mobile communication system according to claim 1, further comprising a first core network node,
wherein the UE sends a UE identifier of the UE to the first core network node via the RAN node, and obtains the AS security context included in a second message received from the RAN node,
wherein the first core network node fetches the AS security context based on the UE identifier, and sends a third message including the AS security context to the RAN node, and
wherein the RAN node obtains the AS security context included in the third message and sends the second message including the AS security context to the UE.

3. The mobile communication system according to claim 2, further comprising a second core network node configured to receive the UE identifier from the first core network node, and fetch the AS security context based on the UE identifier, and send the obtained AS security context,
wherein the AS security context included in the third message is fetched by the first core network node and the second core network node.

4. The mobile communication system according to claim 1,
wherein the UE obtains the AS security context provided by a core network.

5. The mobile communication system according to claim 4,
wherein the RAN node obtains the AS security context provided by the core network.

6. A mobile communication system comprising:
a user equipment (UE) configured to obtain an access stratum (AS) security context of the UE, encrypt a first message or sensitive information element (IE) included in the first message containing Network Slice Selection Assistance Information (NSSAI) using the AS security context, and send the first message;
a first core network node configured to receive the first message from the UE, decrypt the first message or the sensitive IE using the AS security context, and send a second message including the AS security context and the decrypted part of the first message or the decrypted first message; and
a radio access network (RAN) node configured to receive the second message from the first core network node, and obtain the AS security context and the NSSAI.

7. The mobile communication system according to claim 6,
wherein the UE sends a UE identifier of the UE to the first core network node via the RAN node, and
wherein the first core network node fetches the AS security context based on the UE identifier.

8. The mobile communication system according to claim 7, further comprising a second core network node configured to receive the UE identifier from the first core network node, and fetch the AS security context of the UE based on the UE identifier, and send the obtained AS security context,
wherein the AS security context included in the second message is fetched by the first core network node and the second core network node.

9. The mobile communication system according to claim 5,
wherein the UE obtains the AS security context provided by a core network.

10. A communication method for a user equipment (UE), the communication method comprising:
receiving, from a radio access network (RAN) node, an access stratum (AS) security context of the UE,
encrypting a first message or sensitive information element (IE) included in the first message containing Network Slice Selection Assistance Information (NSSAI) using the AS security context, and
sending, to the RAN node, the first message.

11. The communication method according to claim 10, further comprising:
transmitting, to the RAN node, an identifier of last registered core network node, wherein the RAN node uses the identifier for obtaining the AS security context.

12. A communication method for a radio access network (RAN) node, the communication method comprising:
transmitting, to a user equipment (UE), an access stratum (AS) security context of the UE, and
receiving, from the UE, a first message or sensitive information element (IE) included in the first message containing Network Slice Selection Assistance Information (NSSAI) encrypted by using the AS security context.

13. The communication method according to claim 12, further comprising:
receiving, from the UE, an identifier of last registered core network node;
transmitting, to a core network node, the identifier; and
receiving, from the core network node, the AS context related to the identifier.

14. A user equipment (UE) comprising:
a transceiver circuit and a controller,
wherein the controller configured to:
receive, from a radio access network (RAN) node, an access stratum (AS) security context of the UE,
encrypt a first message or sensitive information element (IE) included in the first message containing Network Slice Selection Assistance Information (NSSAI) using the AS security context, and
send, to the RAN node, the first message.

15. A radio access network (RAN) node comprising:
a transceiver circuit and a controller,
wherein the controller configured to:
transmit, to a user equipment (UE), an access stratum (AS) security context of the UE, and
receive, from the UE, a first message or sensitive information element (IE) included in the first message containing Network Slice Selection Assistance Information (NSSAI) encrypted by using the AS security context.
